(19) United States
(12) Patent Application Publication
(10) Pub. No.: US 2008/0285561 A1
(43) Pub. Date: Nov. 20, 2008

(54) Systems and methods for Internet Protocol transparency

(76) Inventors: Brian E. Tuchten, Belleville, IL (US); Timothy K. Burgener, Collinsville, IL (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/803,939

(22) Filed: May 16, 2007

(51) Int. Cl. H04L 12/56

(52) U.S. Cl. 370/392

(57) ABSTRACT

A method for implementing IP transparency includes requesting an IP address from an Internet service provider (ISP), receiving a first IP address from the ISP responsive to requesting an IP address from the ISP, receiving a request for an IP address from a communication device, sending the first IP address to the communication device responsive to receiving the request for an IP address from the communication device, receiving a first IP packet from the communication device, and sending the first IP packet to the ISP. The first IP packet has the first IP address as a source address in a header of the first IP packet.

### BACKGROUND

The Internet is a worldwide, publicly accessible network of interconnected computer networks that transmit data by using an Internet Protocol (IP). It is a “network of networks” that consists of millions of smaller domestic, academic, business, and government networks, which together carry various information and services, such as electronic mail, online chat, file transfer, and the interlinked Web pages and other documents of the World Wide Web. The Internet allows computer users to connect to other computers and information stores easily, wherever they may be across the world. Computer users may do this with or without the use of security, authentication and encryption technologies, depending on security requirements. Access to the Internet is typically provided via a wired connection (e.g., a telephone line) to an Internet service provider (ISP). Communication with an ISP can be achieved using various types of modems, such as, for example, a voice-band modem or a digital subscriber line (DSL) modem, a community access television system modem, etc. Sometimes access to the Internet is interrupted for several minutes or even hours due a problem with an ISP server or a network component (e.g., a DSL modem) used to connect a user's computer to the ISP server.

### SUMMARY

Systems and methods for Internet Protocol (IP) transparency are disclosed. An embodiment of a method for implementing IP transparency includes requesting an IP address from an Internet service provider (ISP), receiving a first IP address from the ISP responsive to requesting an IP address from the ISP, receiving a request for an IP address from a communication device, sending the first IP address to the communication device responsive to receiving the request for an IP address from the communication device, receiving a first IP packet from the communication device, and sending the first IP packet to the ISP. The first IP packet has the first IP address as a source address in a header of the first IP packet.

An embodiment of a system for implementing IP transparency includes a point-to-point protocol (PPP) interface module configured to request an Internet Protocol (IP) address from an Internet service provider (ISP) and to receive a first IP address from the ISP responsive to requesting an IP address from the ISP, and a dynamic host control protocol (DHCP) module configured to receive a request for an IP address from a communication device and to send the first IP address to the communication device responsive to receiving the request for an IP address from the communication device. The system is configured to receive a first IP packet from the communication device and to send the first IP packet to the ISP. The first IP packet has the first IP address as a source address in a header of the first IP packet.

Other systems, methods, features, and advantages of the systems and methods for IP transparency will be or become apparent to one with skill in the art upon examination of the following figures and detailed description. It is intended that all such additional systems, methods, features, and advantages be included within this description, be within the scope of the present disclosure, and be protected by the accompanying claims.

### BRIEF DESCRIPTION OF THE FIGURES

The systems and methods for IP transparency can be better understood with reference to the following figures. The components within the figures are not necessarily to scale, emphasis instead being placed upon clearly illustrating the principles of the systems and methods. Moreover, in the figures, like reference numerals designate corresponding parts throughout the different views.

FIG. 1A is a block diagram depicting an embodiment of a communication system.

FIG. 1B is a block diagram depicting another embodiment of a communication system.

FIG. 2A is a flow chart depicting an embodiment of an IP transparency method.

FIG. 2B is a flow chart depicting another embodiment of an IP transparency method.

FIG. 3 is a flow chart depicting yet another embodiment of an IP transparency method.

FIG. 4 is a flow chart depicting a further embodiment of an IP transparency method.

FIG. 5 is a flow chart depicting an additional embodiment of an IP transparency method.

FIG. 6 is a diagram depicting an example of communication between components of the communication system of FIG. 1.

FIG. 7 is a block diagram illustrating an embodiment of an IP transparency device.

### DETAILED DESCRIPTION

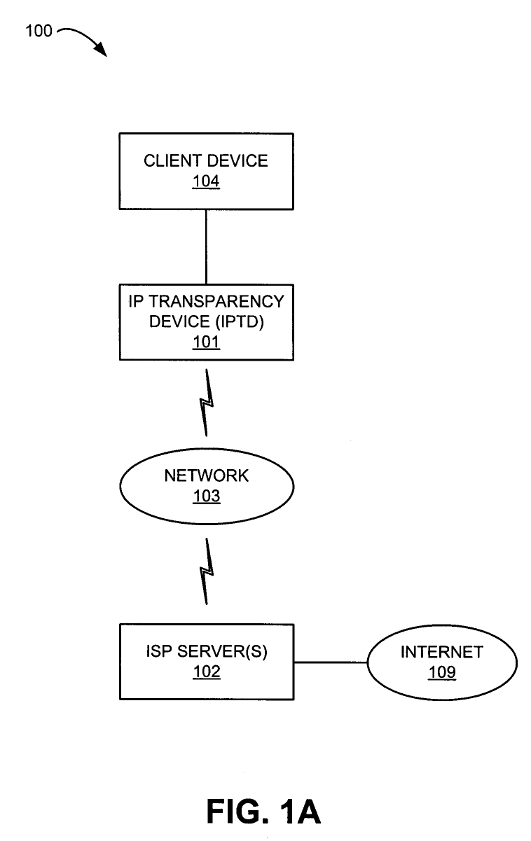

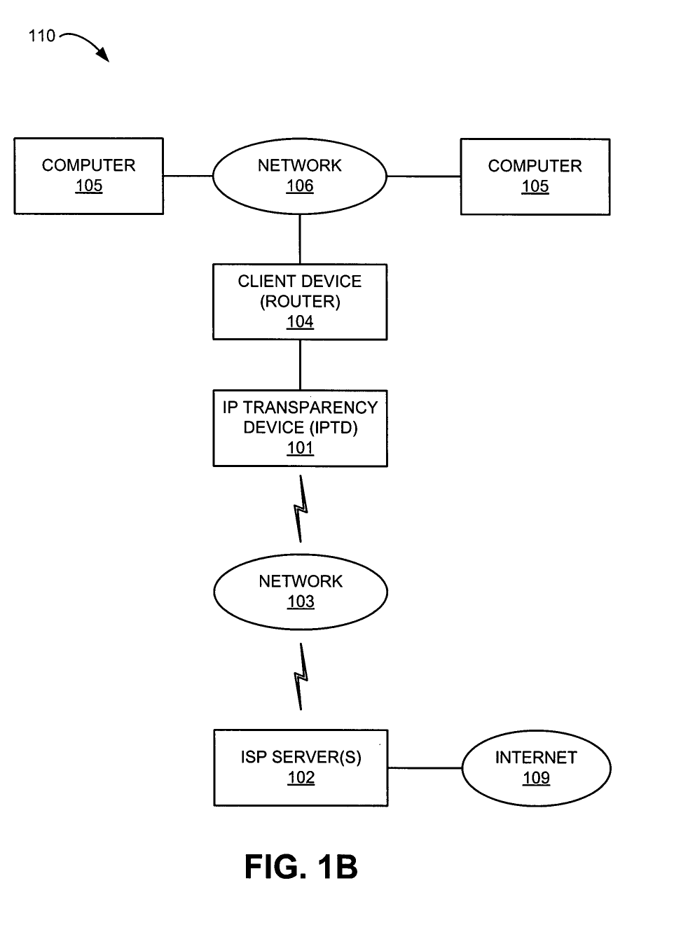

FIG. 1A is a block diagram depicting an embodiment of a communication system 100. The communication system 100 includes an Internet protocol transparency device (IPTD) 101, an Internet service provider (ISP) server 102, a network 103, the Internet 109, and a client device 104. IPTD 101 is communicatively coupled to the ISP server 102 via the network 103. The IPTD 101 communicates with the ISP server 102 via either a wired or wireless interface, depending on a desired implementation. The network 103 can be, for example, among others, a third generation technology (3G) wireless network.

IPTD 101 is communicatively coupled to the client device 104 either directly or via a network (not shown in FIG. 1A). IPTD 101 enables the client device 104 to access the Internet 109 by providing the client device 104 with access to the ISP server 102. IPTD 101 can function as a router and/or a bridge. In an embodiment, the client device 104 is a computer such as, for example, a personal computer (PC). In another embodiment, the client device 104 is a router that routes IP packets between computers 105 (FIG. 1B) and IPTD 101.

In an embodiment, IPTD 101 uses a wireless communication interface (e.g., a wireless communication card) to communicate with the ISP server 102 via a wireless network. The ability of IPTD 101 to have wireless Internet access enables the client device 104 to access the Internet 109 via the IPTD 101. Providing the client device 104 with Internet access via IPTD 101 is advantageous where a wired network connection (e.g., via a telephone line) used by the client device 104 is disrupted.

FIG. 1B is a block diagram depicting an embodiment of a communication system 110. The communication system 110 includes an IPTD 101, an ISP server 102, a network 103, the Internet 109, a client device 104, and computers 105. IPTD 101 is communicatively coupled to the ISP server 102 via network 103. The IPTD 101 communicates with the ISP server 102 via either a wired or wireless interface, depending on a desired implementation.

IPTD 101 is communicatively coupled to the client device 104 either directly or via a network (not shown in FIG. 1B). The client device 104 is communicatively coupled to computers 105 via a network 106. In this embodiment, the client device 104 is a router that enables computers 105 to access the Internet 109 by routing IP packets between computers 105 and IPTD 101.

In an embodiment, IPTD 101 uses a wireless communication interface (e.g., a wireless communication card) to communicate with the ISP server 102 via a wireless network. The ability of IPTD 101 to have wireless Internet access enables the computers 105 to access the Internet 109 via the IPTD 101. Providing the computers 105 with access to the Internet 109 via IPTD 101 is advantageous where a wired Internet connection (e.g., via a telephone line) used by the computers 105 is disrupted.

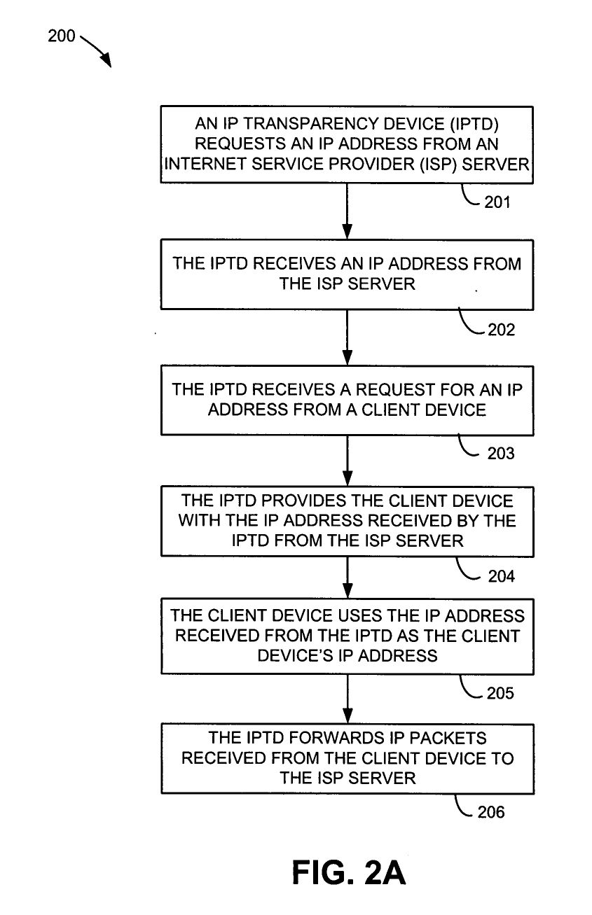

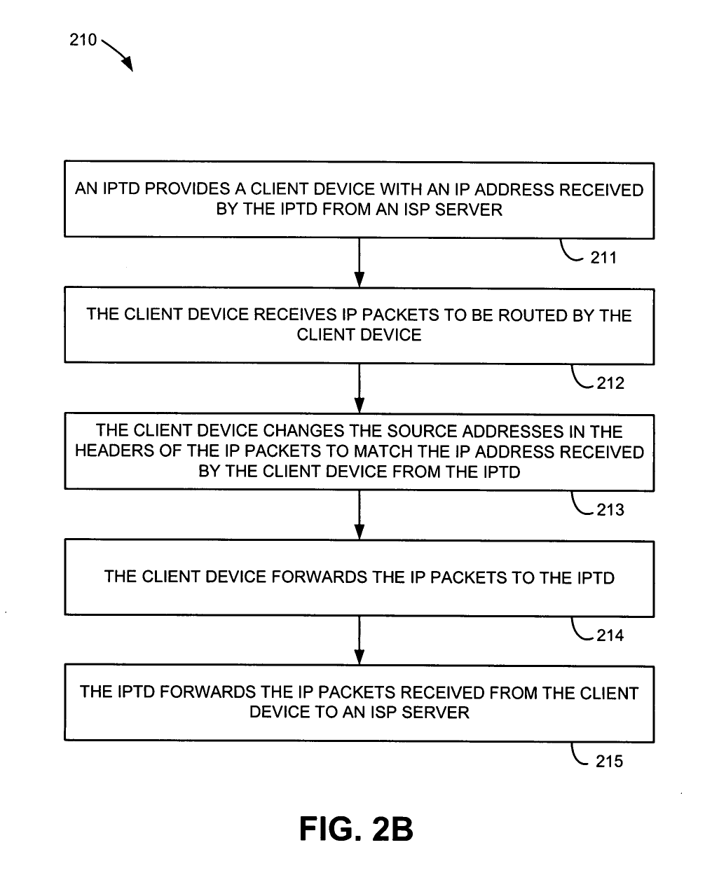

FIG. 2A is a flow chart depicting an embodiment of an IP transparency method 200 which can be implemented by an IPTD 101 (FIGS. 1A and 1B). The IP transparency method 200 enables a client device 104 to access the Internet via the IPTD 101. As indicated in step 201, an IPTD 101 requests an IP address from an Internet service provider (ISP) server 102 (FIGS. 1A and 1B). The IPTD 101 then receives an IP address from the ISP server 102, as indicated in step 202.

The IPTD 101 then receives a request for an IP address from a client device 104 (FIG. 1A or 1B), as indicated in step 203. The IPTD 101 provides the client device 104 with the IP address received by the IPTD 101 from the ISP server 102, as indicated in step 204. The client device 104 uses the IP address received from the IPTD 101 as the client device's 104 IP address, as indicated in step 205. For example, the client device 104 inserts the IP address received from the IPTD 101 in the source address portions of respective IP packet headers transmitted by the client device 104 to the IPTD 101. The IPTD 101 then forwards IP packets received from the client device 104 to the ISP server 102, as indicated in step 206. Note that packets may be forwarded by the IPTD 101 to an ISP server 102 other than the ISP server 102 that provided the IPTD 101 with the IP address.

In an embodiment, the IPTD 101 only forwards packets received from the client device 104 if such packets have respective packet header source addresses that are equal to the IP address received by the IPTD 101 from the ISP server 102. This is to avoid the server 102 terminating a communication session with the IPTD 101 as a result of the ISP server 102 receiving packets having source addresses different from the IP address provided by the ISP server 102 to the IPTD 101. Note that the IPTD 101 can use the IP address received by the IPTD 101 from the ISP server 102 as a source address for packets originating from the IPTD 101. In other words, both the IPTD 101 and the client device 104 can use the same IP address provided by the ISP server 102 as their respective IP addresses.

FIG. 2B is a flow chart depicting an embodiment of an IP transparency method 210. The IP transparency method 210 enables a client device 104 and/or computers 105 to access the Internet or other networks via an IPTD 101 (FIG. 1B). As indicated in step 211, an IPTD 101 provides a client device 104 with an IP address received by the IPTD 101 from an ISP server 102 (FIG. 1B). The client device 104 receives IP packets to be routed by the client device 104, as indicated in step 212. The client device 104 receives the IP packets from, for example, a computer 105. The client device 104 changes the source addresses in the headers of the IP packets to match the IP address received by the client device 104 from the IPTD 101, as indicated in step 213.

The client device 104 then forwards the IP packets to the IPTD 101, as indicated in step 214. The IPTD 101 in turn forwards the IP packets received from the client device 104 to an ISP server 102, as indicated in step 215. Note that packets may be forwarded by the IPTD 101 to an ISP server 102 other than the ISP server 102 that provided the IPTD 101 with the IP address. In an embodiment, the IPTD 101 only forwards packets received from the client device 104 if such packets have source addresses in their respective packet headers that match the IP address received by the IPTD 101 from the ISP server 102.

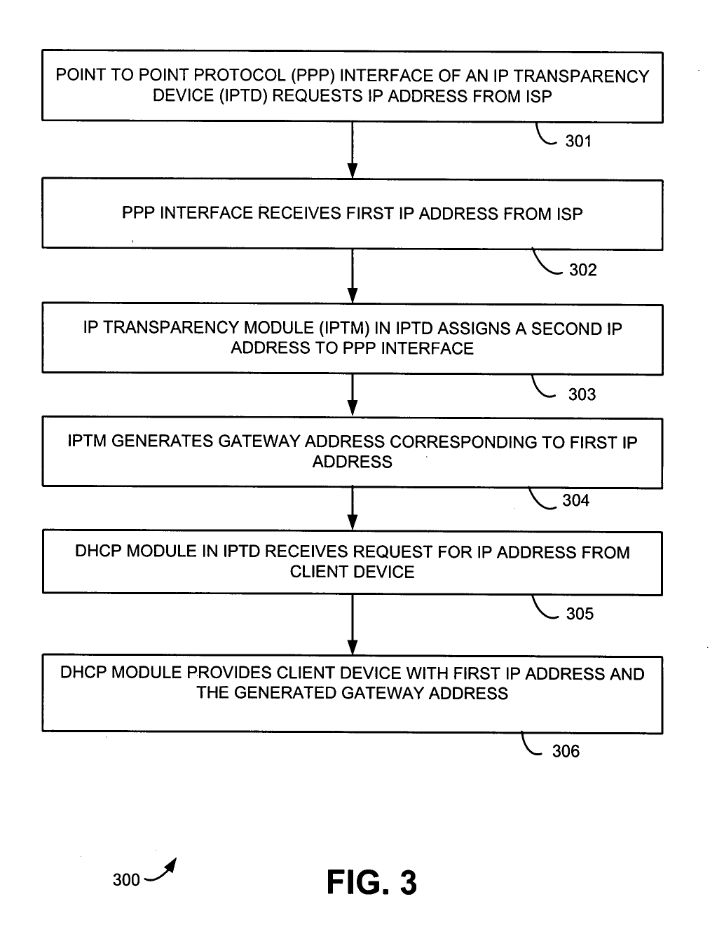

FIG. 3 is a flow chart depicting an embodiment of an IP transparency method 300. The IP transparency method 300 enables a client device 104 to access the Internet or other networks via an IPTD 101 (FIGS. 1A and 1B). As indicated in step 301, a point to point protocol (PPP) interface of an IPTD 101 requests an IP address from an ISP server 102. The PPP interface then receives a first IP address from the ISP server 102, as indicated in step 302.

An IP transparency module (IPTM) in the IPTD 101 then assigns a second IP address to the PPP interface, as indicated in step 303. The second IP address is an IP address that is different from the first IP address. In an embodiment, the second IP address is a private IP address. The IPTM generates a gateway IP address corresponding to first IP address, as indicated in step 304. The gateway IP address can be generated by, for example, adding or subtracting a pre-determined numeral to the first IP address. In an embodiment, the pre-determined numeral is 1.

A dynamic host control protocol (DHCP) module in the IPTD 101 receives a request for an IP address from the client device 104, as indicated in step 305. The DHCP module then provides the client device 104 with the first IP address and the generated gateway IP address, as indicated in step 306. The first IP address is then used by the client device 104 as the client device 104's IP address.

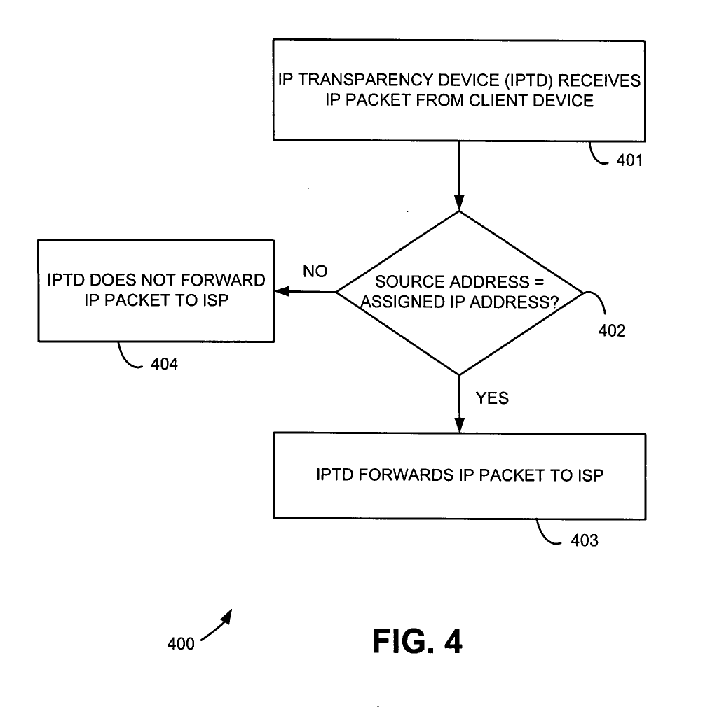

FIG. 4 is a flow chart depicting an embodiment of an IP transparency method 400. The IP transparency method 400 enables a client device 104 to access the Internet or other networks via an IPTD 101 (FIGS. 1A and 1B). As indicated in step 401, an IPTD 101 receives an IP packet from a client device 104. A determination is then made by the IPTD 101 as to whether the source address in the IP packet received from the client device 104 is the same as the IP address provided by the IPTD 101 to the client device 104, as indicated in step 402. If the source address of the IP packet received from the client device 104 is the same as the IP address provided by the IPTD 101 to the client device 104, then the IPTD 101 forwards the IP packet to an ISP server 102, as indicated in step 403. If, however, the source address in the IP packet received from the client device 104 is not the same as the IP address provided by the IPTD 101 to the client device 104, then the IPTD 101 does not forward IP packet to the ISP server 102, as indicated in step 404. One reason for not forwarding packets that do not have the IP address provided by the IPTD 101 to the client device 104 is to prevent the ISP server 102 from terminating the communication session between the ISP server 102 and the IPTD 101.

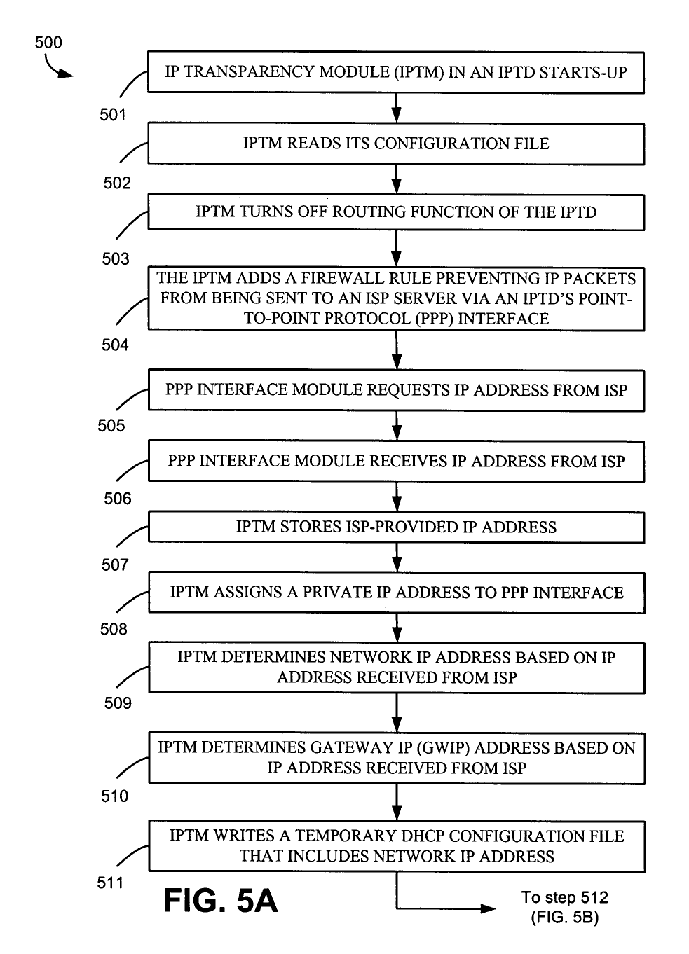

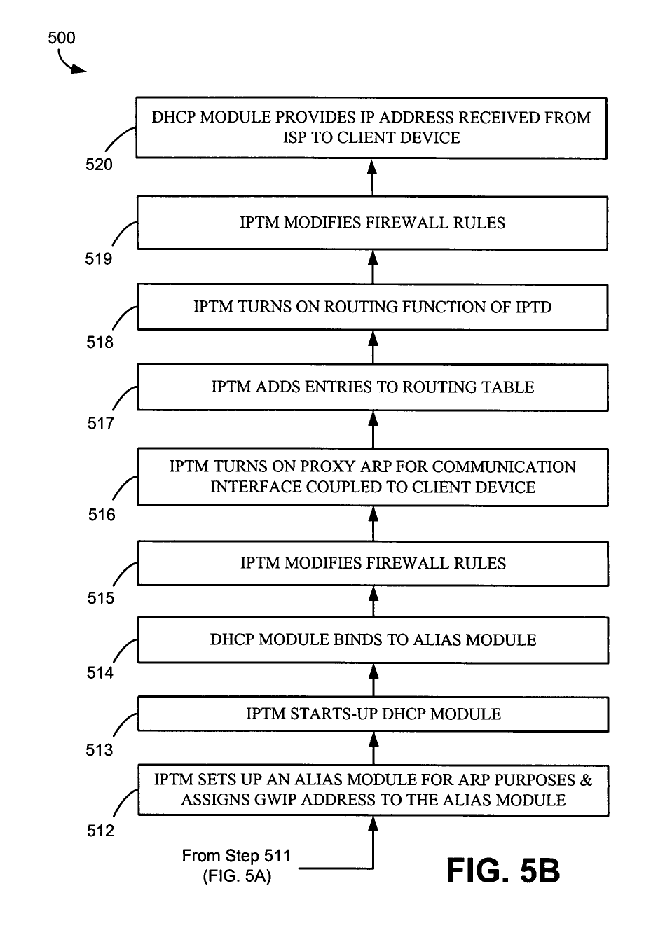

FIG. 5 is a flow chart depicting an embodiment of an IP transparency method 500. The IP transparency method 500 enables a client device 104 to access the Internet or other networks via an IPTD 101 (FIGS. 1A and 1B). As indicated in step 501, an IP transparency module (IPTM) in an IPTD 101 starts-up. The IPTM then reads its configuration file, as indicated in step 502, and turns off routing functions of the IPTD, as indicated in step 503. The IPTM then adds a firewall rule preventing IP packets from being sent to an ISP server 102 via an IPTD 101's point-to-point protocol (PPP) interface, as indicated in step 504.

The PPP interface then requests an IP address from the ISP server 102 (FIGS. 1A and 1B), as indicated in step 505. The ISP server 102 sends an IP address to the IPTD 101 responsive to the IPTD 101's request for an IP address. The PPP interface module then receives the IP address from the ISP server 102, as indicated in step 506. The IPTM stores the ISP-provided IP address, as indicated in step 507.

The IPTM then assigns a private IP address to the PPP interface, as indicated in step 508. For example, among others, the IPTM assigns to the PPP interface the IP address 192.168.255.254 and a Point-to-Point IP address of 192.168.255.1. Of course many alternative private IP address can be assigned to the PPP interface. The IPTM also determines a network IP address (for DHCP purposes) based on the ISP-provided IP address, as indicated in step 509. Various network IP addresses can be determined using various methods. One method, for example, would be to convert the final quarter of the ISP-provided IP address to zero. For example, assuming the ISP-provided IP address is 1.2.3.4, then the network IP address can be determined to be 1.2.3.0.

The IPTM then determines a gateway IP (GWIP) address based on the ISP-provided IP address, as indicated in step 510. Various GWIP addresses can be determined using various methods. One method, for example, would be to add a value of 1 to the final quarter of the ISP-provided IP address if such final quarter of the IP address is less than 255, and to subtract a value of 1 from the final quarter of the IP address if such final quarter of the IP address is equal to 255. Using such method, if the ISP-provided IP address is, for example, 1.2.3.4, then the GWIP would be determined to be 1.2.3.5. Another approach for determining a GWIP address could include, for example, adding and/or subtracting other values from the IP address received from the ISP.

The IPTM writes a temporary DHCP configuration file that includes the network IP address, as indicated in step 511. For example, the IPTM writes a temporary DHCP file indicating that the IP range is 1.2.3.0/255.255.255.0, the IP address to be given out is 1.2.3.4, the corresponding netmask is 255.255.255.255, and the GWIP address is 1.2.3.5. The DHCP configuration file is used by a DHCP module in the IPTD 101 to provide a client device 104 with an IP address, a corresponding netmask and a GWIP address.

The IPTM sets up an alias module for implementing address resolution protocol (ARP) functionality. ARP is a protocol for enabling a device to find another device's hardware address. The IPTM also assigns the GWIP to the alias module, as indicated in step 512. For example, the alias module can correspond to a predetermined Ethernet port (e.g., Ethernet 1:99) and can have an IP address equal to the GWIP (e.g., 1.2.3.5). The IPTM then starts-up the DHCP module, as indicated in step 513. After starting-up, the DHCP module binds to the alias module, as indicated in step 514.

The IPTM then modifies firewall rules, as indicated in step 515. The following are examples of firewall rule modifications according to an embodiment, among others, of method 500: (a) Post-routing network address translation (NAT) rule: drop any packet intended to leave the IPTD 101 via the PPP interface coupled to the ISP server 102, if such packet does not have the ISP-provided IP address as a source address in its header. (b) Input rule: accept user datagram protocol (UDP) destination port 67 packets received via an Ethernet port (e.g., Ethernet 0 or Ethernet 1) configured by the IPTM to enable communication with the client device 104. (c) Input rule: drop any packet received via the physical Ethernet port that is coupled to the client device 104 if such packet does not have the ISP-provided IP address as a source address in its header. (d) Forward rule: drop any packet originating from any IP interface in the IPTD 101 if such packet is intended to leave the IPTD 101 via the PPP interface coupled to the ISP server 102. (e) Forward rule: drop any packet received via the Ethernet port configured by the IPTM to enable communication with the client device 104 if such packet does not have the ISP-provided IP address as a source address in its header. (f) Output rule: accept Internet Control Message Protocol (ICMP) type 8 echo request packets having a source IP address equal to the IP address assigned to the PPP interface (e.g., 192.168.255.254) if such packets are intended to leave the IPTD 101 via the PPP interface coupled to the ISP server 102. (g) Output rule: drop all other ICMP packets (i.e., packets that are not ICMP type 8 echo request packets) if such packets are intended to leave the IPTD 101 via the PPP interface coupled to the ISP server 102. (h) Pre-routing NAT rule: accept UDP destination port 67 packets received via an Ethernet port configured by the IPTM to enable communication with the client device 104. (i) Pre-routing NAT rule: drop any packet received via the physical Ethernet port that is coupled to the client device 104 if such packet does not have the ISP-provided IP address as a source address in its header. (j) Pre-routing NAT rule: route packets having an IP port address equal to an address of an IPTD 101 IP port to the corresponding IPTD 101 IP port. (k) Output NAT rule: accept ICMP type 8 echo request packets having a source IP address equal to the IP address assigned to the PPP interface (e.g., 192.168.255.254) if such packets are intended to leave the IPTD 101 via the PPP interface coupled to the ISP server 102. (l) Output NAT rule: drop all other ICMP packets (i.e., packets that are not ICMP type 8 echo request packets) with source IP 192.168.255.254 if such packets are intended to leave the IPTD 101 via the PPP interface coupled to the ISP server 102.

The IPTM then turns on proxy ARP for a communication interface (e.g., Ethernet 1 or Ethernet 2) coupled to the client device 104, as indicated in step 516. The proxy ARP allows the client device 104 that is communicatively coupled to the IPTD 101 to use ARP to receive information about IP addresses that the IPTD 101 can provide (e.g., a point-to-point address that the client device 104 can use to communicate with the IPTD 101).

The IPTM then adds entries to a routing table, as indicated in step 517. For example, the IPTM can add a route entry that enables IP packets having a destination address of 1.2.3.4 to be routed to the client device 104 via Ethernet 1. The IPTM then turns on the IPTD 101's routing function, as indicated in step 518, and modifies firewall rules, as indicated in step 519. Examples of how the IPTM modifies firewall rules include cancelling the firewall rule added in step 504 and adding a source NAT rule that ensures that IP packets being sent to the ISP server 102 have a source IP address equal to the ISP-provided IP address. After the firewall rules are modified in step 519, the DHCP module provides the ISP-provided IP address to the client device 104, as indicated in step 520. The ISP-provided IP address can then be used by the client device 104 as its IP address.

Note that in some embodiments the functions noted in the various blocks may occur out of the order depicted in the flow charts described above. For example, two or more blocks shown in a flow chart may, in fact, be executed substantially concurrently. By way of further example, two or more blocks may, in fact, be executed in the reverse order or in some other order depending upon the functionality involved.

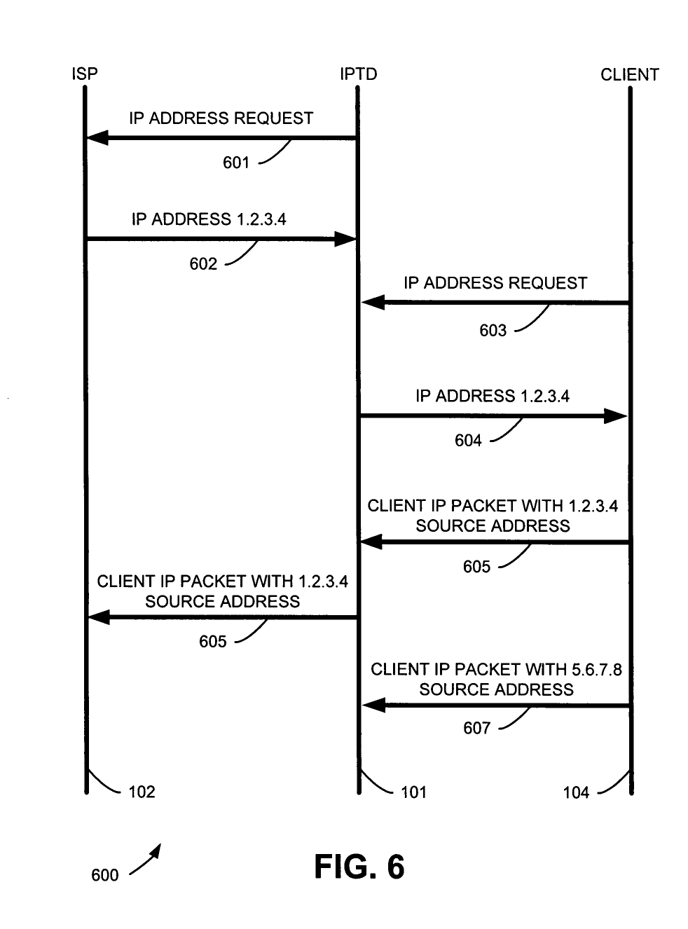

FIG. 6 is a diagram depicting an example of communication between components of the communication system 100 (FIG. 1). As shown in FIG. 6, an IPTD 101 sends a request 601 for an IP address to an ISP server 102 (FIG. 1). The ISP server 102 then sends to IPTD 101 a response 602 comprising an IP address that can be used by IPTD 101. In this example, the IP address provided by ISP 102 is 1.2.3.4. Of course, many other alternative IP addresses could be provided by ISP 102 but 1.2.3.4 is chosen in this example for illustrative purposes. The client device 104 then sends a request 603 for an IP address to IPTD 101. IPTD 101 sends the client device 104 a response 604 comprising the IP address 1.2.3.4 that IPTD 101 received from the ISP server 102.

The client device 104 then sends an IP packet 605 to IPTD 101. The IP packet 605 includes as a source address the IP address 1.2.3.4 received by the client device 104 from IPTD 101. IPTD 101 examines the IP packet 605 to determine if it includes as its source address the IP address 1.2.3.4 provided by IPTD 101 to the client device 104. After determining that the IP packet 605 includes 1.2.3.4 as its source address, IPTD 101 forwards the IP packet 605 to the ISP server 102.

The client device 104 sends another IP packet 607 to IPTD 101. The IP packet 607 includes as its source address an IP address 5.6.7.8 that is different than the IP address received by the client device 104 from IPTD 101. IPTD 101 examines the IP packet 607 to determine if the IP packet 607 includes 1.2.3.4 as its source address. After determining that the IP packet 605 does not include 1.2.3.4 as its source address, IPTD 101 does not forward the IP packet 607 to the ISP server 102. Instead, IPTD 101 essentially “drops” the IP packet 607.

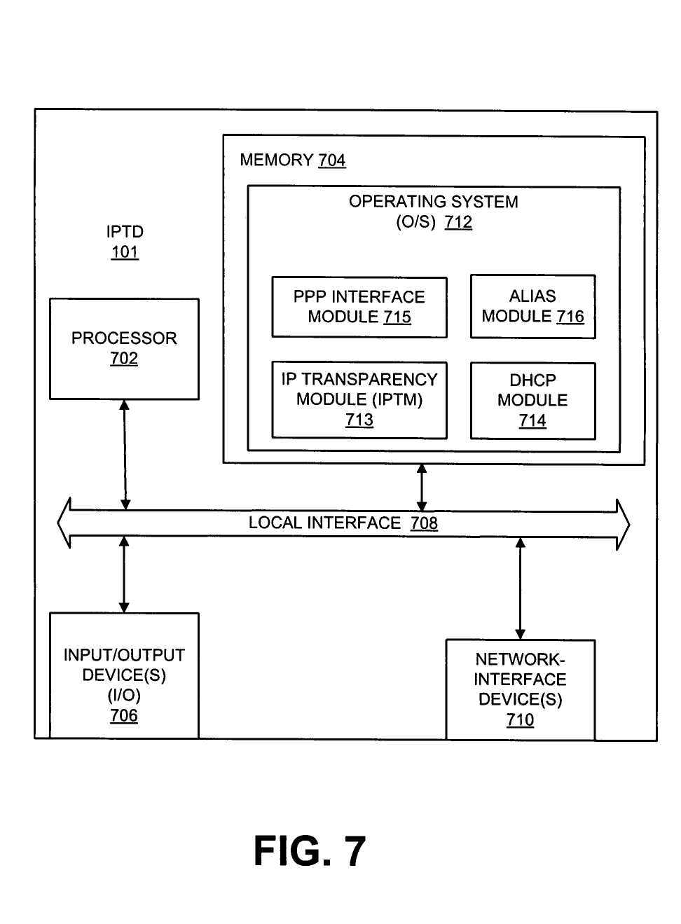

FIG. 7 is a block diagram illustrating an embodiment of an IPTD 101. The IPTD 101 includes a processor 702, memory 704, network interface device(s) 710, and one or more user input and/or output (I/O) device(s) 706 (or peripherals) that are communicatively coupled via a local interface 708.

The local interface 708 can be, for example but is not limited to, one or more buses or other wired or wireless connections, as is known in the art. The local interface 708 might have additional elements, which are omitted for simplicity, such as controllers, buffers (caches), drivers, repeaters, and receivers, to enable communications. Further, the local interface 708 might include address, control, and/or data connections to enable appropriate communications among the aforementioned components.

The processor 702 is a hardware device for executing software, particularly that stored in memory 704. The processor 702 can be any custom made or commercially available processor, a central processing unit (CPU), an auxiliary processor among several processors, a semiconductor based microprocessor (in the form of a microchip or chip set), or generally any device for executing software instructions.

The memory 704 can include any one or combination of volatile memory elements (e.g., RAM, such as DRAM, SRAM, SDRAM, etc.) and nonvolatile memory elements (e.g., ROM, flash memory, etc.). Moreover, the memory 704 might incorporate electronic, magnetic, optical, and/or other types of storage media. Note that the memory 704 can have a distributed architecture, where various components are situated remote from one another, but can be accessed by the processor 702.

The user I/O device(s) 706 includes input devices such as, for example but not limited to, a keyboard, a mouse, a scanner, a microphone, and/or a touch sensitive display, etc. Furthermore, the user I/O device(s) 706 also include output devices such as, for example, but not limited to, a printer, a speaker, and/or a display, etc. The network interface device(s) 710 include, for example, a modem, a radio frequency (RF) or other transceiver, a telephonic interface, and/or an Ethernet interface.

Software stored in memory 704 may include one or more separate programs, each one of which comprises an ordered listing of executable instructions for implementing logical functions. In the example of FIG. 7, the software in the memory 704 includes an operating system 712, a PPP interface module 715, an IP transparency module (IPTM) 713, and a DHCP module 714.

Among other things, the operating system 712 essentially controls the execution of modules 713-716 and provides scheduling, input-output control, file and data management, memory management, and communication control and related services. The PPP interface module 715 is configured to communicate with an ISP server 102 (FIGS. 1A and 1B) using a point-to-point protocol (PPP). The DHCP module 714 is configured to provide a client device 104 with an IP address. The IPTM 713 is configured to generate an IP address corresponding to the PPP interface module 715, modify firewall rules, and perform other IPTM functions discussed above. The alias module 716 is configured to implement address resolution protocol (ARP) functionality.

The modules 713-716 can be source programs, executable programs (object code), scripts, or any other entities comprising a set of instructions to be performed. When implemented as source programs, the modules 713-716 are translated via a compiler, assembler, interpreter, or the like, which may or may not be included within the memory 704, so as to operate properly in connection with the O/S 712. Furthermore, the modules 713-716 can be written in one or more object oriented programming languages, which have classes of data and methods, or procedure programming languages, which have routines, subroutines, and/or functions.

The foregoing description has been presented for purposes of illustration and description. It is not intended to be exhaustive or to limit the scope of the claims to the illustrative embodiments disclosed above. Such embodiments were chosen and described to enable one of ordinary skill in the art to implement various systems and methods for IP transparency. Many modifications or variations to the embodiments are possible in light of the above teachings. Such modifications and variations are within the scope of the appended claims when interpreted in accordance with the breadth to which they are fairly and legally entitled.

What is claimed is:

1. A method comprising:
requesting an Internet Protocol (IP) address from an Internet service provider (ISP);
receiving a first IP address from the ISP responsive to requesting an IP address from the ISP;
receiving a request for an IP address from a communication device;
sending the first IP address to the communication device responsive to receiving the request for an IP address from the communication device;
receiving a first IP packet from the communication device, wherein the first IP packet has the first IP address as a source address in a header of the first IP packet; and
sending the first IP packet to the ISP.

2. The method of claim 1, wherein sending the first IP packet to the ISP is responsive to determining that the first IP packet has the first IP address as a source address in a header of the first IP packet.

3. The method of claim 1, further comprising:
generating a gateway IP address based on the first IP address; and
sending the gateway IP address to the communication device.

4. The method of claim 3, wherein the gateway IP address is generated by adding a predetermined integer to the first IP address.

5. The method of claim 4, wherein the predetermined integer is equal to 1.

6. The method of claim 1, wherein the communication device is a router.

7. A router configured to implement the method of claim 1.

8. The method of claim 1, further comprising generating a network IP address based on the first IP address.

9. The method of claim 1, wherein requesting an IP address from the ISP and receiving the first IP address from the ISP are achieved via a wireless network.

10. The method of claim 1, wherein requesting an IP address from the ISP and receiving the first IP address from the ISP is performed via a point-to-point protocol (PPP) interface.

11. The method of claim 10, further comprising assigning a second IP address to the PPP interface, wherein the second IP address is different from the first IP address.

12. The method of claim 1, wherein the second IP address is a private IP address.

13. The method of claim 1, wherein a dynamic host control protocol (DHCP) module is used to receive the request for an IP address from the communication device and to send the first IP address to the communication device.

14. The method of claim 1, further comprising:
receiving a second IP packet from the ISP; and
sending the second IP packet to the communication device responsive to determining that a destination address in a header of the second IP packet is equal to the first IP address.

15. The method of claim 1, wherein receiving the request for an IP address from the communication device and sending the first IP address to the communication device is achieved via an Ethernet interface.

16. A system comprising:
a point-to-point protocol (PPP) interface module configured to request an Internet Protocol (IP) address from an Internet service provider (ISP) and to receive a first IP address from the ISP responsive to requesting an IP address from the ISP;
a dynamic host control protocol (DHCP) module configured to receive a request for an IP address from a communication device and to send the first IP address to the communication device responsive to receiving the request for an IP address from the communication device;
wherein the system is configured to receive a first IP packet from the communication device and to send the first IP packet to the ISP, the first IP packet having the first IP address as a source address in a header of the first IP packet.

17. The system of claim 16, wherein the system is configured to send the first IP packet to the ISP responsive to the system determining that the first IP packet has the first IP address as a source address in a header of the first IP packet.

18. The system of claim 16, wherein the system is a router.

19. The system of claim 16, further comprising:
an IP transparency module configured to assign a second IP address to the PPP interface module, wherein the second IP address is different from the first IP address; and

20. The system of claim 16, wherein the system is further configured to:
receive a second IP packet from the ISP; and
send the second IP packet to the communication device responsive to determining that a destination address in a header of the second IP packet is equal to the first IP address.
